(19) United States
(12) Patent Application Publication
(10) Pub. No.: US 2026/0230535 A1
(43) Pub. Date: Aug. 6, 2026

(54) Artificial Intelligence (AI) Manipulated Media Detection Across Telecommunications Networks

(71) Applicant: BOOST SUBSCRIBERCO L.L.C., Englewood, CO (US)

(72) Inventor: Bassem Abi-Farah, Littleon, CO (US)

(21) Appl. No.: 19/042,575

(22) Filed: Jan. 31, 2025

(51) Int. Cl. H04L 67/53; G06F 21/10; G06V 40/16; G06V 40/20; G10L 25/51; H04L 67/306

(52) U.S. Cl. CPC H04L 67/53; G06F 21/1011; H04L 67/306; G06V 40/168; G06V 40/20; G10L 25/51

(57) ABSTRACT

Systems and methods to detect AI manipulation of media in telecommunications network. One system may include a processing system. The processing system may be configured to receive a media item published to a media platform such that the media item is made publicly accessible via the media platform. The processing system may be configured to determine that the media item involves an entity included in a list of entities to be monitored. The processing system may be configured to provide the media item to an AI model, the AI model to determine whether the media item includes a manipulated representation of the entity. The processing system may be configured to receive, from the AI model, an indication of whether the media item includes the manipulated representation of the entity. The processing system may be configured to execute an action with respect to the media item based on the indication.

### BACKGROUND

Wireless networks that transport digital data and telephone calls are becoming increasingly sophisticated. Currently, fifth generation (5G) broadband cellular networks are being deployed around the world. These 5G networks use emerging technologies to support data and voice communications with millions, if not billions, of mobile phones, computers, and other devices. 5G technologies are capable of supplying much greater bandwidths than previously available technologies.

The discussion above is merely provided for general background information and is not intended to be used as an aid in determining the scope of the claimed subject matter.

### SUMMARY

Various aspects of the present disclosure relate to artificial intelligence (AI) manipulated media detection across telecommunications networks, and, in particular, to real-time (or near real-time) AI manipulated media detection across 5G networks.

According to one aspect of the present disclosure, a system to detect artificial intelligence (AI) manipulation of media within a telecommunications network. The system may comprise a processing system including one or more electronic processors configured to: receive a media item published to a media platform such that the media item is made publicly accessible via the media platform; determine that the media item involves an entity included in a list of entities to be monitored; provide the media item to an artificial intelligence (AI) model, the AI model to determine whether the media item includes a manipulated representation of the entity; receive, from the AI model, an indication of whether the media item includes the manipulated representation of the entity; and execute an action with respect to the media item based on the indication.

According to another aspect of the present disclosure, a method to detect artificial intelligence (AI) manipulation of media within a telecommunications network. The method may include receiving, with a processing system including one or more electronic processors, a media item published to a media platform such that the media item is made publicly accessible via the media platform. The method may include determining, with the processing system, that the media item involves an entity included in a list of entities to be monitored. The method may include providing, with the processing system, the media item to an artificial intelligence (AI) model, the AI model to determine whether the media item includes a manipulated representation of the entity. The method may include receiving, with the processing system, from the AI model, an indication of whether the media item includes the manipulated representation of the entity. The method may include executing, with the processing system, an action with respect to the media item based on the indication.

According to another aspect of the present disclosure, a non-transitory computer-readable medium storing instructions that, when executed by one or more electronic processors of a processing system in a telecommunications network, may cause the processing system to perform operations comprising: receiving a media item; determining that the media item involves an entity included in a list of entities to be monitored; providing the media item to an artificial intelligence (AI) model, the AI model to determine whether the media item includes manipulated content related to the entity; receiving, from the AI model, an indication of whether the media item includes manipulated content related to the entity; and executing an action with respect to the media item based on the indication.

### BRIEF DESCRIPTION OF THE DRAWINGS

The following drawings are provided to help illustrate various features of examples of the disclosure and are not intended to limit the scope of the disclosure or exclude alternative implementations.

FIG. 1 illustrates an example of a telecommunications network in accordance with various aspects of the present disclosure.

FIG. 2 illustrates an example of a service-based architecture for a telecommunications network in accordance with various aspects of the present disclosure.

FIG. 3 schematically illustrates an example of a server in accordance with various aspects of the present disclosure.

FIG. 4 schematically illustrates an example of a detection server in accordance with various aspects of the present disclosure.

FIG. 5 is a flowchart of an example method to detect artificial intelligence (AI) manipulation of media within a telecommunications network in accordance with various aspects of the present disclosure.

### DETAILED DESCRIPTION

The disclosed technology is not limited in its application to the details of construction and the arrangement of components set forth in the following description or illustrated in the following drawings. Other examples of the disclosed technology are possible and examples described and/or illustrated here are capable of being practiced or of being carried out in various ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology can be implemented in software (for example, stored on non-transitory computer-readable medium) executable by one or more electronic processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computing device or can be distributed among different computing devices connected by one or more networks or other suitable communication links.

The present disclosure is directed to wireless communications networks, also referred to herein as telecommunications networks. The wireless communications networks described herein may represent a portion of a wireless network built around 5G standards promulgated by standards setting organizations under the umbrella of the Third Generation Partnership Project (“3GPP”). Accordingly, in some configurations, the wireless communication network may be a 5G network, such as, e.g., a 5G cellular network. Such 5G networks, including the wireless communication networks described herein, may comply with industry standards, such as, e.g., the Open Radio Access Network (Open RAN or O-RAN) standard that describes interactions between the network and user equipment (UE) (e.g., mobile phones and the like). As another example, the wireless communication networks described herein may comply with other industry standards, such as, e.g., the Distributed Radio Access Network (Distributed RAN or D-RAN) or the like. In some configurations, the wireless communication network may be another type of wireless network, such as, for example, a sixth generation (6G), wireless network.

D-RAN enables the distribution of radio access functions and the separation of control and user plane functions, which allows for the deployment of RAN functions in various locations, such as, e.g., remote radio heads (RRHs) and baseband units (BBUs). The BBUs may process the control plane functions and the user plane functions and the RRHs may handle radio frequency (RF) processing. Accordingly, D-RAN allows for the deployment of virtualized RAN functions such that RAN functions can be executed as software via a cloud infrastructure.

The O-RAN model follows a virtualized model for a 5G wireless architecture in which 5G base stations, referred to as next-generation Node Bs (gNBs), are implemented using separate centralized units (CUs), distributed units (DUs), and radio units (RUs). In some configurations, O-RAN CUs and DUs may be implemented using software modules executed by distributed (e.g., cloud) computing hardware. Virtualization allows for various other components of the cellular network, such as cellular network core functions, to be implemented as code that is executed using computing resources. Such computing resources can be part of a public cloud-computing platform that provides virtual private clouds (VPCs) for multiple clients. On a hybrid cloud cellular network, RAN components of the cellular network are in communication with components of the cellular network executed on a public cloud computing platform, such as, e.g., Amazon Web Services (AWS), Azure, Google Cloud, or any private or public cloud(s).

Accordingly, the technology disclosed herein provides methods and systems to detect AI manipulated media across telecommunications networks. In some configurations, the technology disclosed herein may relate to detecting AI manipulated media in real-time (or near real-time) across 5G networks.

AI manipulated media (also referred to as “deepfake(s)”) generally includes fake (or fictitious) content that is generated using AI technologies (e.g., as a type of synthetic media). In some cases, AI manipulated media (or deepfakes) is originated with an intent to confuse or deceive an end-user. While AI manipulated media may, in some instances, include genuine (or authentic) content, at least a portion of the AI manipulated media may be fake. In some instances, whether media includes manipulated content (or is AI manipulated media all together) may not be readily discernable to an end user interacting with the AI manipulated media. As such, AI manipulated media may cause confusion, mistrust, disorder, harm to reputations or relationships, or the like by, e.g., spreading fake (or false) information that has the potential to be confused or misinterpreted as real (or true) information. As one specific example, the impact of AI manipulated media may be palpable during (or relating to) public events, such as, e.g., presidential or state elections, where public opinion may be open to various interpretations in order to decide between, e.g., proposed laws, plans, or candidates.

Since internet communications primarily happen on cellular communications, which are managed by operators (or carriers), the technology disclosed herein may relate to a security solution to monitor and control AI manipulated data for implementation on telecommunications networks (e.g., 5G telecommunications networks). In some configurations, the technology disclosed herein may be activated by a receiving entity, mandated by a governing entity or public authority, etc.

For example, the technology disclosed herein may implement AI manipulated media detection on end-user communication devices (e.g., UE, as described in greater detail herein) using 5G connectivity. In some configurations, the technology disclosed herein may implement the AI manipulated media detection with respect to a list of entities or objects, such as, e.g., public figures, political candidates, notable organizations, etc. While the technology disclosed herein is generally described in relation to public figures or individuals holding prominent positions in the public eye (e.g., celebrities, highly publicized individuals, political figures or candidates, viral social media influencers, etc.), the technology disclosed herein may be implemented with respect to any various entities or objects, such as, e.g., plants, inanimate objects, animals, non-public figures or entities (individuals or entities not holding prominent positions in the public eye), etc.

In some configurations, the technology disclosed herein may be implemented with a 5G network as a backbone. For instance, the technology disclosed herein may utilize the ultra-low latency and high bandwidth of 5G such that end-user devices (or UE) can offload computationally expensive AI manipulated detection tasks to edge servers or cloud-based systems in real-time (or near real-time). In some configurations, the technology disclosed herein may utilize cloud-based AI models. For instance, high-powered AI models, such as, e.g., for video and audio analysis, may reside on cloud servers or edge computing nodes, which ensures that the end-user devices (or UEs) do not need the heavy computational power but can still process deepfake detection efficiently via the 5G network. In some configurations, the technology disclosed herein may be provide targeted high-profile monitoring. For example, in some cases, the technology disclosed herein may provide specialized detection processes for public figures, such as, e.g., presidential candidates. Such specialized detection processes may include AI models trained on authentic characteristics, appearances, voices, etc. of such public figures such that the AI models can help distinguish genuine content from fake content.

In some configurations, the technology disclosed herein may monitor incoming media (e.g., videos, images, audio, etc.) sent or shared via, e.g., messaging applications, social media platforms, news outlets, or another type of media platform. The technology disclosed herein may flag content for further analysis when the content involves an entity to be monitored (e.g., contains footage of a public figure). The technology disclosed herein may be implemented using 5G-powered processing. For instance, using 5G, a phone may upload suspected media files to a cloud or edge AI system, where advanced neural networks, generative adversarial networks (GANs), and detection models may analyze the content for inconsistencies in facial movements, lighting, voice anomalies, image distortions, etc. In some instances, the technology disclosed herein may provide real-time (or near real-time) feedback). For example, the cloud or edge AI system may process the results and send feedback to a user in real-time (or near real-time), and, in some instances, marking the content as verified, suspicious, or clearly a manipulated content.

As described herein, the technology may implement various AI models. As one example, the technology described herein may implement deep learning models that may be trained on legitimate media content of entities to be monitored (e.g., videos and images of public figures). The technology described herein may constantly update databases with new verified media from reliable sources (e.g., presidential speeches, official broadcasts, etc.). As another example, the technology described herein may implement audio analysis. For instance, an audio recognition model may be implemented to analyze speech patterns, inflection, background noise, tone of voice, etc. for consistency. As another example, the technology described herein may implement behavioral monitoring. For instance, the AI model(s) may track a subject's typical behavior, body language, mannerisms, etc., which may further assist in flagging AI manipulated media.

In some configurations, the technology described herein may provide alerts, such as, e.g., automatic alerts. As one example, when a user receives or interacts with media featuring a monitored entity, the technology disclosed herein may trigger (e.g., automatically trigger) AI manipulated media detection. When suspicious elements are detected in the media, an alert may be generated to notify the user. Alternatively, or in addition, the technology disclosed herein may facilitate user-initiated scanning. For example, a user may manually request AI manipulated media detection on any media shared to them, ensuring proactive scanning of media content.

Further, since sensitive media may be analyzed, the technology disclosed herein may ensure that user data remains encrypted throughout the upload and detection process. Thus, the technology disclosed herein may provide end-to-end encryption.

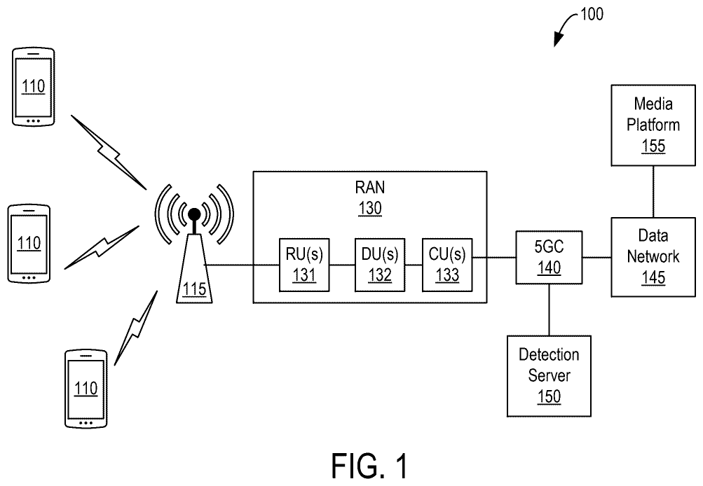

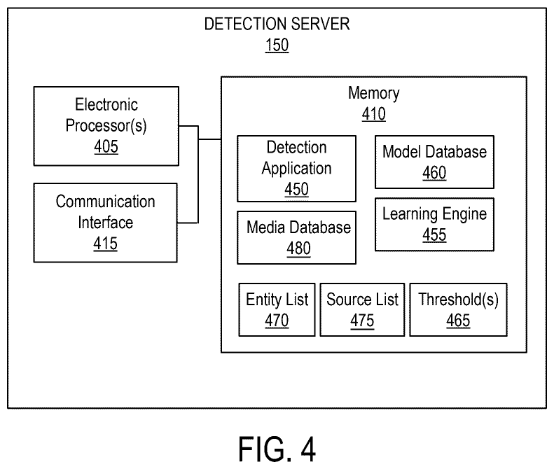

FIG. 1 illustrates an example of a telecommunications network 100 in accordance with various aspects of the present disclosure. In the telecommunications network 100 of FIG. 1, one or more user equipment (UE) 110 may be connected to a wireless access point 115, which in turn may be connected to a radio access network (RAN) 130, including, e.g., one or more radio units (RUs) 131, distributed units (DUs) 132, centralized units (CUs) 133, or a combination thereof. In some configurations, the RAN 130 may be implemented as a virtualized RAN 130. As noted herein, the O-RAN model follows a virtualized model for a 5G wireless architecture in which 5G base stations (e.g., gNBs) are implemented using separate CUs, DUs, and RUs. In some configurations, O-RAN CUs and DUs may be implemented using software modules executed by distributed (e.g., cloud) computing hardware. Virtualization allows for various other components of the cellular network, such as cellular network core functions, to be implemented as code that is executed using computing resources. Accordingly, in some configurations, the RAN 130 may be implemented in accordance with the O-RAN model, such that the RUs 131, the DUs 132, or CUs 133 may be O-RAN RUs, CUs, or DUs. The RAN 130 may provide a connection to a 5G core network (5GC) 140, which in turn may provide a connection to a data network 145, a detection server 150, a media platform 155, another component or device, or a combination thereof. The data network 145 may be the Internet, an enterprise data network, combinations thereof, or the like. The detection server 150 is described in greater detail herein with respect to FIG. 4. The wireless access point 115 and the RAN 130 may collectively be referred to as a next-generation RAN (NG-RAN).

The media platform 155 may facilitate or provide a media service or application accessible via the data network 145. In some examples, the media platform 155 may allow users to create, share, or interact with media items (also referred to herein as media content). A media item may represent digital media or content, such as, e.g., a piece of digital media or content. The media item may be in various formats or forms. For example, the media item may include text, one or more images (e.g., photographs, illustrations, infographics, etc.), audio (e.g., a podcast, a voice recording, an audio book, etc.), one or more videos (e.g., a movie, a short video clip, etc.), one or more interactive contents (e.g., a website, a video game, etc.), etc. In some configurations, a media item may be a piece of media or content that may be made accessible via the media platform 155. In some instances, a media item may be (or otherwise include), such as, e.g., an audio file, an image file, a movie file, another type of electronic file, etc. In some instances, a media item may be a social media post (e.g., an image posted to a social media account). As another example, a media item may be a website (e.g., interactive content). In some examples, the media platform 155 may be a social media platform. Alternatively, or in addition, the media platform 155 may be another type of platform that provides a service or application related to accessing or interacting with media.

While the media platform 155 and the detection server 150 are illustrated as separate components from the 5GC 140, in some configurations, the media platform 155, the detection server 150, or a combination thereof (or functionality thereof) may be implemented via the 5GC 140 (e.g., may sit on top of the 5GC 140).

In some configurations, the telecommunications network 100 may be a standalone (SA) network (e.g., a 5G SA network) that utilizes 5G cells for both signaling and information transfer via a 5G packet core architecture. However, the present disclosure may be implemented with any type of telecommunication network, including, e.g., a telecommunication network capable of being virtualized. For instance, in some implementations, the telecommunication network 100 may be implemented using one or more virtualized RAN components, such as, e.g., one or more virtualized RUs, virtualized DUs, virtualized CUs, or a combination thereof. In some configurations, the telecommunication network 100 may be implemented pursuant to the O-RAN model, as described herein. Accordingly, in some instances, the telecommunications network 100 may be an O-RAN telecommunications network.

As used herein, the term “UE” may be one of various types of end-user devices, such as a cellular phone, a smartphone, a cellular modem, a cellular-enabled computerized device, a sensor device, robotic equipment, a vehicle, an Internet of Things (IoT) device, a gaming device, an access point (AP), a two-way radio, a walkie-talkie, or any computerized device capable of communicating via a cellular network. More generally, the UEs 110 can represent any type of device that has an incorporated 5G interface, such as, e.g., a 5G modem. Examples can include a sensor device, an IoT device, a manufacturing robot, an unmanned aerial (or land-based) vehicle, a network-connected vehicle, etc. Depending on the location of individual UEs 110, the UEs 110 may use radio frequency (RF) to communicate with various base stations of a telecommunications network (e.g., the wireless access point 115 of the telecommunications network 100 of FIG. 1). While FIG. 1 illustrates three UEs 110 connected to the wireless access point 115, in practical implementations any number of UEs 110 may be connected to the wireless access point 115 at any given time.

The wireless access point 115 may represent the physical infrastructure (e.g., a 5G tower or base station) to which the UE(s) 110 connects. The wireless access point 115 may be any structure to which one or more antennas are mounted. The wireless access point 115 may be a dedicated cellular tower, a building, a water tower, or any other man-made or natural structure to which one or more antennas can reasonably be mounted to provide cellular coverage to a geographic area.

The wireless access point 115 may include the RU(s) 131. The RU(s) 131 are configured to convert radio signals sent to and received from the antenna(s) into a digital signal. The wireless access point 115 is connected to the RAN components 130 via a fronthaul link over which the digital signals may be communicated. The DU(s) 132 may be connected to the CU(s) 133 via a midhaul link. The CU(s) 133 may be connected to the 5 GC 135 via a backhaul link. While FIG. 1 illustrates a single wireless access point 115, in practical implementations the telecommunications network 100 may include any number of wireless access points 115.

In one example, the telecommunications network 100 may be configured according to a region-based network topology. For example, the telecommunications network 100 may be implemented using a cloud computing platform that is logically and physically divided up into various different cloud computing regions (e.g., AWS regions). The cloud computing regions may be based on the geographical location of the gNBs; for example, the telecommunications network 100 for a given nation may be divided into a number of geographical regions. Each of the cloud computing regions can be isolated from other cloud computing regions to help provide fault tolerance, fail-over, load-balancing, and/or stability and each of the cloud computing regions can be composed of multiple availability zones or markets, each of which can be a separate data center located in general proximity to each other (e.g., within 100 miles). For example, one cloud computing region may have its datacenters and hardware located in the northeast of the United States while another cloud computing region may have its data centers and hardware located in California.

Each of the availability zones may be a discrete data center or group of data centers that allows for redundancy, thereby to provide fail-over protection from other availability zones within the same cloud computing region. For example, when a particular data center of an availability zone experiences an outage, another data center of the availability zone or separate availability zone within the same cloud computing region can continue functioning and providing service. An availability zone may be divided into multiple local zones or areas-of-interest (AOIs). For instance, a client, such as a provider of the telecommunications network 100, can select from more options of the computing resources that can be reserved at an availability zone compared to a local zone. However, a local zone may provide computing resources nearby geographic locations where an availability zone is not available. Each local zone may be divided into multiple gNBs, each of which can serve one or more sites. A site may have one DU 132 and a number of RUs 131 (e.g., six RUs 131) assigned to it.

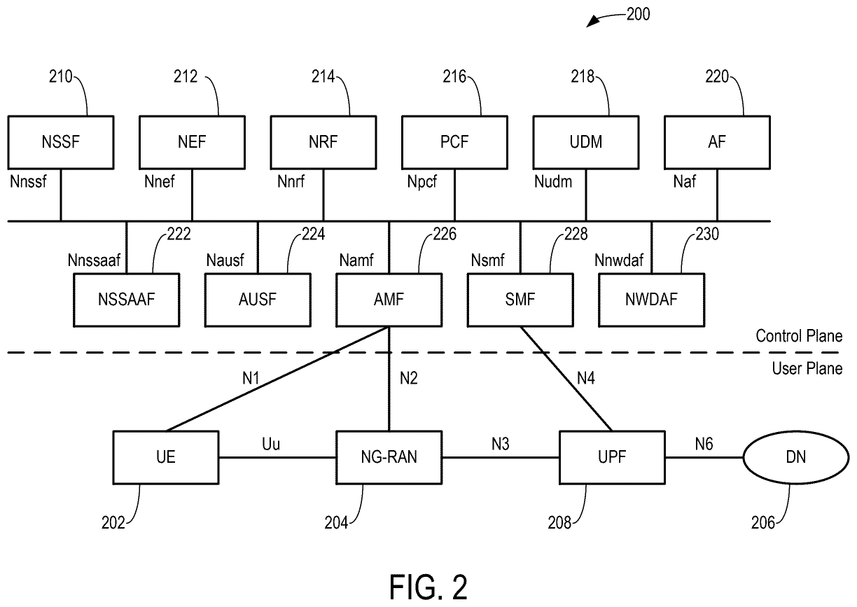

The 5GC 140 provides a plurality of 5G core functions. In the topology of a 5G NR cellular network, 5G core functions of 5GC 140 can logically reside as part of a national data center (NDC). An NDC can be understood as having its functionality existing in a cloud computing region across multiple availability zones. This arrangement allows for load-balancing, redundancy, and fail-over. In local zones, multiple regional data centers can be logically present. Each of regional data centers may execute 5G core functions for a different geographic region or group of RAN components. An example of 5G core components that can be executed within a regional data center (RDC) are described in more detail with regard to FIG. 2. The data network 145 may be the Internet, an enterprise data network, combinations thereof, or the like.

FIG. 2 illustrates an example architecture 200 for a telecommunications network (e.g., the telecommunications network 100 of FIG. 1) in accordance with various aspects of the present disclosure. In some instances, the architecture 200 may be a service-based architecture (SBA), such as, e.g., a SBA based on HTTP2. The architecture 200 may be divided between a control plane (CP) and a user plane (UP). The CP may include a plurality of CP network functions (NFs). The UP may include a UE 202 (e.g., one of the UEs 110 of FIG. 1) connected to an NG-RAN 204, and UP NFs (e.g., a User Plane Function (UPF) 208). In some implementations, using the architecture 200, the UE 202 may access a data network 206 (e.g., the data network 140 of FIG. 1). For ease of illustration, FIG. 2 only shows a single UE 202 being connected to the NG-RAN 204; however, in practical implementations, any number of UEs 202 may be present, limited only by the capacity of the network. Any of the NFs illustrated in FIG. 2 and/or described herein may be implemented as a software unit residing on a server (i.e., in the cloud).

The UP NFs may include a User Plane Function (UPF) 208. The UPF 208 is a NF that routes and forwards UP data packets between the base station (cell site; for example, the NG-RAN 204) and the data network 206 (e.g., the Internet). The UPF 208 may be similar to the service and packet gateway functions in a 4G network, but the UPF 208 is cloud-native and can be deployed anywhere to meet service requirements. The UPF 208 can also manage, prioritize, and duplicate data packets as those data packets traverse the network, thus offering redundancy and quality-of-service (QoS) assurance.

The CP NFs may include a Network Slice Selection Function (NSSF) 210, a Network Exposure Function (NEF) 212, a Network Repository Function (NRF) 214, a Policy Control Function (PCF) 216, a Unified Data Management (UDM) 218, an Application Function (AF) 220, a Network Slice-specific and SNPN Authentication and Authorization Function (NSSAAF) 222, an Authentication Server Function (AUSF) 224, an Access and Mobility Management Function (AMF) 226, a Session Management Function (SMF) 228, and a Network Data Analytics Function (NWDAF) 230.

The NSSF 210 may be a CP function that provides network slices to the AMF 226. A network slice is an independent, end-to-end logical network that runs on shared physical network infrastructure. The network slice involves the allocation of network resources across all network infrastructure to meet specific service requirements, from the network core to the RAN. Specific requirements may include QoS assurance, security policies, data isolation, dynamic policy management, etc.

The NEF 212 may be a CP function that provides information regarding the NFs that are available to use (by the enterprise customer). The NEF 212 may be similar to the 4G Service Capabilities Exposure Function (SCEF), but the NEF 212 is cloud-native and exposes event information, network monitoring, network control, provisioning capabilities, and policy/charging capabilities externally. This allows the enterprise customer to monitor and affect QoS and charging for devices.

The NRF 214 may be a CP function that allows 5G NFs to be registered, discovered, and subsequently made available to customers. This is a unique capability in the SA 5G network that allows customers to subscribe to the necessary microservices or to have dedicated NFs for their services.

The PCF 216 may be a CP function that provides policies for mobility and session management. The PCF 216 may be similar to the Policy and Charging Rules Function (PCRF) in a 4G network, but the PCF 216 is cloud-native and offers additional capabilities in the 5G network, including event-based policy triggers, resource reservation requests, and access network discovery and selection. The PCF 216 may directly influence QoS and subscriber spending limits, and, as a result, may play a role in the enhanced policy management and control capabilities of the 5G network.

The UDM 218 may be a CP function that manages and stores subscriber and device information, default QoS and prioritization, authorized data channels, maximum bit rates, service continuity provisions, and the like. The UDM 218 may be similar to the Home Subscriber Server (HSS) function in a 5G network, but the UDM 218 is cloud-native and designed for 5G services.

The AF 220 may be a CP function that interacts with the 3GPP Core Network in order to provide services, for example, to support one or more of application function influence on traffic routing, application function influence on service function chaining, accessing the NEF 212, interacting with the PCF 216, time synchronization service, IP multimedia subsystem (IMS) interactions with the 5GC, or packet data unit (PDU) set handling.

The NSSAAF 222 may be a CP function that supports authentication and authorization of slicing with an AAA server (Authentication, Authorization, and Accounting). The NSSAAF 222 may be a unique capability of the SA 5G network that allows customers to access a predefined network slice or a newly requested network slice in real-time (or near real-time) and using their own existing authentication infrastructure.

The AUSF 224 may be a CP function that supports authentication for 3GPP access and untrusted non-3GPP access, and authentication of a UE for a disaster roaming service. The AUSF 224 can act as an authentication server.

The AMF 226 may be a CP function that manages registration, authorization, connection, reachability, and mobility. The AMF 226 may be similar to the Mobility Management Entity (MME) function in a 4G network, but the AMF 226 is cloud-native and supports many additional capabilities unique to 5G. For example, the AMF 226 may also support dynamic updating of network interfaces and cellular sites, greater privacy via the use of a 5G temporary device identity, enhanced security across the user and control planes, and storing of network slice information. The AMF 226 can also select an appropriate PCF for a device or use case.

The SMF 228 may be a CP function that oversees packet data session management, IP address allocation, data tunneling from a cell site base station to the UP function, and downlink notification management. The SMF 228 may perform the tasks of the serving and packet gateways (S-GW & P-GW) in a 4G network, but also allows for CP and UP separation in 5G.

The NWDAF 230 may be a CP function that collects data from pertinent network infrastructure relevant to a customer's services, including UE (device), NFs, network operations and administration, cloud, and edge that can be used for data analytics and insights. The NWDAF 230 may be a unique SA 5G NF that exposes full visibility to network performance and operations as they relate to a customer's key performance indicators (KPIs).

The SBA 200 may further include a plurality of service-based interfaces to provide access to or communication with the various NFs. As illustrated, such service-based interfaces may include an Nnssf interface for the NSSF 210, an Nnef interface for the NEF 212, an Nnrf interface for the NRF 214, an Npcf interface for the PCF 216, an Nudm interface for the UDM 218, an Naf interface for the AF 220, an Nnssaaf interface for the NSSAAF 222, an Nausf interface for the AUSF 224, an Namf interface for the AMF 226, an Nsmf interface for the SMF 228, and an Nnwdaf interface for the NWDAF 230. FIG. 1 also illustrates several reference points (i.e., interfaces between two NFs or entities), including an N1 interface between the UE 202 and the AMF 226, a Uu interface between the UE 202 and the NG-RAN 204, an N2 interface between the NG-RAN 204 and the AMF 226, an N3 interface between the NG-RAN 204 and the UPF 208, an N4 interface between the UPF 208 and the SMF 228, and an N6 interface between the UPF 208 and the data network 206.

The above-listed NFs and interfaces are intended to be illustrative and not exhaustive. In practical implementations, the SBA 200 may include additional NFs or other network entities, such as an Unstructured Data Storage Function (UDSF), a Network Slice Admission Control Function (NSCAF), a Unified Data Repository (UDR), a UE radio Capability Management Function (UCMF), a 5G-Equipment Identity Register (5G-EIR), a Charging Function (CHF), a Time Sensitive Networking AF (TSN AF), a Time Sensitive Communication and Time Synchronization Function (TSCTSF), a Data Collection Coordination Function (DCCF), an Analytics Data Repository Function (ADRF), a Messaging Framework Adaptor Function (MFAF), a Non-Seamless WLAN Offload Function (NSWOF), an Edge Application Server Discovery Function (EASDF), a Service Communication Proxy (SCP), a Security Edge Protection Proxy (SEPP), a Non-3GPP InterWorking Function (N3IWF), a Trusted Non-3GPP Gateway Function (TNGF), a Wireline Access Gateway Function (W-AGF), or a Trusted WLAN Interworking Function (TWIF).

For purposes of explanation, the technology disclosed herein will be described as being implemented in a 5G O-RAN network; however, in practice, the technology disclosed herein may be implemented with any RAN architecture (including, e.g., any virtualized RAN architecture). Moreover, for purposes of explanation, the systems and methods described herein will be described as being implemented in a network operating using AWS; however, these are merely examples and not limiting. The systems and methods of the present disclosure may be implemented with other web services provider and with other container organization architectures. The methods described herein may be performed by a processing system including at least one electronic processor, where the at least one electronic processor may be or include a processor as described herein (e.g., including one or more individual electronic processors). A data center server is an example of such a processing system that may perform the methods described herein.

As described herein with respect to FIG. 1, the 5GC 140 provides a plurality of 5G core functions, which may reside and/or execute via one or more data centers (e.g., one or more NDCs or RDCs), including, e.g., one or more data center servers. For instance, in some configurations, the data center server(s) may store and execute a set of instructions for executing one or more NF as described herein. Additionally, in some embodiments, the data center server may be a local server located at corresponding cell site(s) (e.g., as part of an on-site computing platform of a corresponding wireless access point 115 or cell site). Alternatively, or in addition, in some embodiments, the data center server may be a remote cloud server located remotely from the corresponding cell site(s).

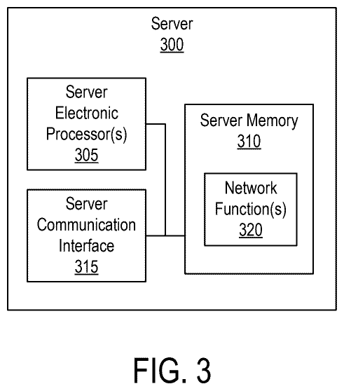

For example, FIG. 3 schematically illustrates an example server 300 (e.g., a data center server for the 5GC 140 of FIG. 1) according to some configurations. As illustrated in FIG. 3, the server 300 includes a server electronic processor 305, a server memory 310, and a server communication interface 315. The server electronic processor 305, the server memory 310, and the server communication interface 315 may communicate wirelessly, over one or more communication lines or buses, or a combination thereof. The server 300 may include additional, different, or fewer components than those illustrated in FIG. 3 in various configurations. The server 300 may perform additional or different functionality than the functionality described herein. Also, the functionality (or a portion thereof) described herein as being performed by the server 300 may be performed by another component (e.g., another data center server or component of the 5GC 140 ), distributed among multiple devices (e.g., as part of a cloud service or cloud-computing environment), combined with another component (e.g., another component of the telecommunications network 100), or a combination thereof.

The server communication interface 315 may include a transceiver that communicates with other components of the telecommunications network 100, such as, e.g., the data network 145, the RAN 130, including, e.g., the RU(s) 131, DU(s) 132, or CU(s) 133, etc. over one or more communication networks or connections. The server electronic processor 305 includes one or more electronic processors (e.g., one or more microprocessors, one or more application-specific integrated circuits (ASICs), and/or one or more other suitable electronic device for processing data), and the server memory 310 includes a non-transitory, computer-readable storage medium. The server electronic processor 305 is configured to retrieve instructions and data from the server memory 310 and execute the instructions. For example, as illustrated in FIG. 3, the server memory 310 may store one or more network functions 320 (also referred to herein as the NFs 320). The NFs 320 may include, e.g., one or more of the network functions described herein, such as, e.g., with respect to FIG. 2.

FIG. 4 schematically illustrates an example detection server 150 according to some configurations. As illustrated in FIG. 4, the detection server 150 includes an electronic processor 405, a memory 410, and a communication interface 415. The electronic processor 405, the memory 410, and the communication interface 415 may communicate wirelessly, over one or more communication lines or buses, or a combination thereof. The detection server 150 may include additional, different, or fewer components than those illustrated in FIG. 4 in various configurations. The detection server 150 may perform additional or different functionality than the functionality described herein. Also, the functionality (or a portion thereof) described herein as being performed by the detection server 150 may be performed by another component or device (e.g., the server 300, another component of the 5GC 140, the media platform 155, or the like), distributed among multiple devices (e.g., as part of a cloud service or cloud-computing environment, such as the server 300, another component of the 5GC 140, the media platform 155, etc.), combined with another component (e.g., another component of the telecommunications network 100), or a combination thereof.

The communication interface 415 may include a transceiver that communicates with other components of the telecommunications network 100, such as, e.g., the data network 145, the media platform 155, the RAN 130, including, e.g., the RU(s) 131, DU(s) 132, or CU(s) 133, etc. over one or more communication networks or connections. The electronic processor 405 includes one or more processors (e.g., one or more microprocessors, one or more ASICs, or one or more other suitable electronic device for processing data), and the memory 410 includes a non-transitory, computer-readable storage medium. The electronic processor 405 is configured to retrieve instructions and data from the memory 410 and execute the instructions.

For example, as illustrated in FIG. 4, the memory 410 may store a detection application 450. The detection application 450 is a software application executable by the electronic processor 405 in the example illustrated and as specifically discussed below, although a similarly purposed module can be implemented in other ways in other examples. In some configurations, the detection application 450 may be a dedicated software application locally stored in the memory 410 of the detection device 400. As described in greater detail herein, the detection application 450 (when executed by the electronic processor 405) may enable or facilitate functionality (e.g., detecting AI manipulated media) in accordance with the technology disclosed herein.

As illustrated in FIG. 4, in some configurations, the memory 410 may also include a learning engine 455 and a models database 460. In some configurations, the learning engine 455 develops a model using an artificial intelligence (AI) or machine learning function. Machine learning functions are generally functions that allow a computer application to learn without being explicitly programmed. In particular, the learning engine 455 is configured to develop a model based on training data. As one example, to perform supervised learning, the training data includes example inputs and corresponding desired (for example, actual) outputs, and the learning engine 455 progressively develops a model that maps inputs to the outputs included in the training data. As another example, to perform self-supervised learning (“SSL”), a model is trained on a task using the data itself to generate supervisory signals (e.g., unlabeled training data), rather than relying on, e.g., external labels provided by a user (e.g., labeled training data). As yet another example, to perform semi-supervised learning, the training data may include desired output values for a subset of the training data (e.g., labeled training data) while the remaining training data may be unlabeled or imprecisely labeled (e.g., unlabeled training data). Machine learning performed by the learning engine 455 may be performed using various types of methods and mechanisms including but not limited to decision tree learning, association rule learning, artificial neural networks, inductive logic programming, support vector machines, clustering, Bayesian networks, reinforcement learning, representation learning, similarity and metric learning, sparse dictionary learning, and genetic algorithms. These approaches allow the learning engine 455 to ingest, parse, and understand data and progressively refine models.

Models generated by the learning engine 455 can be stored in the model database 460. As illustrated in FIG. 4, the model database 460 may be included in the memory 410 of the detection server 150. It should be understood, however, that, in some configurations, the model database 460 may be included in one or more separate devices accessible by the detection server 150 of FIG. 4 (including a remote database, and the like).

As described in greater detail herein, in some configurations, the technology disclosed herein may utilize or implement deep learning (e.g., one or more models) as part of implementing AI manipulated media detection, as described herein. For instance, in some configurations, the learning engine 455 may develop an AI model to detect AI manipulated media (also referred to herein as manipulated content or manipulated representation). The AI model may be an AI or machine learning model trained to evaluate media (or media item(s)) in order to determine whether the media (or media item(s)) include manipulated content.

In some configurations, the learning engine 455 may develop the AI model to extract one or more features or characteristics from the media item in order to determine an authenticity of the media content (or portion(s) therein) (e.g., determine whether the media item includes manipulated content). The feature(s) extracted from the media item may include, e.g., one or more audio features (e.g., a cadence or speed, a word choice, a tonal pitch, a speech pattern, an inflection, a volume, etc.), facial features (e.g., a distance between eyes, a shape of the cheekbones, a contour of the lips, ears, or chin, a hair color, an eye color, etc.), behavioral features (e.g., a movement or gesture, a body language, a gate, a facial expression, a posture, a walking pattern, a speed or duration of a specific behavior, etc.), etc. In some instances, the features extracted from the media item may be based on a media type of the media item, such as, e.g., audio, image, video, etc. In some instances, the extracted features (or characteristics) may be compared with baseline features (or characteristics). When the extracted features are not substantially similar to the baseline features, the AI model may determine that the media item includes manipulated content. When the extracted features are substantially similar to the baseline features, the AI model may determine that the media item does not include manipulated content.

In some examples, the AI model may determine authenticity (e.g., a presence of manipulated content in the media item) using one or more thresholds 465 (or confidence thresholds). For instance, the threshold(s) 465 may establish a minimum confidence level when determining that the media item does or does not include manipulated content. The threshold(s) 465 may represent a confidence or level of certainty with respect to the determination of whether the media item includes manipulated content. The threshold(s) 465 may be represented as a percentage (e.g., 85%, 90%, 95%, etc.). Alternatively, or in addition, the threshold(s) 465 may be represented using another metric or measurement. Accordingly, in some instances, the threshold(s) 465 may correspond to (or otherwise be associated with) a sensitivity of the AI model (e.g., how sensitive the AI model is when detecting AI manipulated media).

In some instances, the threshold(s) 465 may be established (or otherwise set) based on a user preference or setting. As such, in some instances, a user may control a sensitivity level with respect to the detection of AI manipulated media. In some instances, a user may establish a sensitivity level based on one or more of, e.g., a data source, an entity to be monitored, a media type, etc. As one example, a user may establish a first sensitivity level (e.g., a first threshold) for a first data source and a second, different sensitivity level (e.g., a second threshold) for a second, different data source. As another example, a user may establish a first sensitivity level (e.g., a first threshold) for a first entity to be monitored and a second, different sensitivity level (e.g., a second threshold) for a second, different entity to be monitored. In some configurations, the user that establishes the threshold(s) 465 may be an end-user or consumer of the telecommunications network 100 (e.g., such as an individual or business that uses the telecommunications network 100 for personal or professional purposes). As such, in some examples, an end-user may personalize the AI manipulated media detection based on personal preferences or desired customer experience. Alternatively, or in addition, in some configurations, the user that establishes the threshold(s) 465 may be, e.g., a service provider (or agent thereof) of the telecommunications network 100, a regulatory authority (or agent thereof) of the telecommunications network 100, the media platform 155, etc. (e.g., a regulatory entity or a governing entity that oversees or ensures compliance with respect to the telecommunications network 100, the media platform 155, etc.), a media platform provider (or agent thereof) of the media platform 155 (e.g., such as an individual or business that oversees or manages the distribution or publication of media content via the media platform 155), etc.

In some examples, the AI model may determine whether a media item includes manipulated content related to an entity (e.g., includes a manipulated representation of the entity). In some examples, the learning engine 455 may use authenticated (or genuine) media content as training data. As one example, the learning engine 455 may develop an AI model for a particular entity using authenticated (or genuine) media content of that particular entity. Such authenticated (or genuine) media content may include, e.g., content of a public speaking event of the entity, an official broadcast of the entity, etc. As such, in some instances, the AI model may be developed using training data specific to the particular entity (e.g., authenticated media content of the entity) such that the AI model is specific to that particular entity. As such, in some instances, the AI model may be specifically selected (e.g., from a plurality of AI models) based on an entity involved in a corresponding media item.

Alternatively, or in addition, in some instances, the AI model may be specifically selected (e.g., from a plurality of AI models) based on a media type of a corresponding media item. A media item may be, e.g., an audio file (e.g., a recording of an entity), an image file (e.g., a still image, a moving-image, a video stream, other data associated with providing a visual output, etc.), etc. For instance, in some examples, when the media item is an audio file, the AI model may be an audio recognition model, as described in greater detail herein. In other examples, when the media item is an image file, the AI model may be a facial recognition model, a behavioral model, or a combination there, as described in greater detail herein.

In some configurations, the AI model may be an audio recognition model. The audio recognition model may by an artificial intelligence or machine learning model trained to evaluate audio data included in a media item (e.g., audio data, metadata of the audio data, etc.) in order to authenticate the audio data included in the media item, and, ultimately, to determine whether the media item includes a manipulated audio content, such as, e.g., a manipulated representation of the entity with respect to audio data of the entity (e.g., manipulated a voice of the entity, such as, e.g., voice manipulation of the entity). As one example, manipulated audio content of the entity may include, e.g., an audio recording of the entity making a statement, where the audio recording sounds as though the entity made the statement, although the entity did not make the statement.

The learning engine 455 may develop the audio recognition model to extract one or more audio features of the audio data (or the metadata thereof) included in the media item in order to determine an authenticity of the audio data (e.g., determine whether the media content includes manipulated audio content). In some examples, the learning engine 455 may develop the audio recognition model using authenticated (or genuine) audio data of an entity (e.g., public speaking events, official or verified podcasts, etc.) as training data. Based on the training data, the audio recognition model may be specifically trained to recognize (or learn) audio features specific to a particular entity, which may represent an audio signature of a particular entity. An audio signature may be based on, e.g., a learned set of audio features or a baseline of audio features for a particular entity. In some instances, the extracted audio features may be compared with the audio signature of an entity to determine a consistency between the extracted audio features and the audio signature in order to, ultimately, determine whether the media content includes an audio manipulation of the entity.

Alternatively, or in addition, in some configurations, the AI model may be a facial recognition model. The facial recognition model may by an artificial intelligence or machine learning model trained to evaluate image data related to facial features included in a media item (e.g., facial image data) in order to authenticate the facial image data included in the media item, and, ultimately, to determine whether the media item includes manipulated facial content with respect to facial features of the entity.

The learning engine 455 may develop the facial recognition model to extract one or more facial features of the facial image data included in the media item in order to determine an authenticity of the facial image data (e.g., determine whether the media content includes manipulated facial content). In some examples, the learning engine 455 may develop the facial recognition model using authenticated (or genuine) facial image data of an entity as training data. Based on the training data, the facial recognition model may be specifically trained to recognize (or learn) facial features specific to a particular entity, which may represent a facial signature of a particular entity. A facial signature may be based on, e.g., a learned set of facial features or a baseline of facial features for a particular entity. In some instances, the extracted facial features may be compared with the facial signature of an entity to determine a consistency between the extracted facial features and the facial signature in order to, ultimately, determine whether the media content includes a facial manipulation of the entity.

Alternatively, or in addition, in some configurations, the AI model may be a behavioral recognition model. The behavioral recognition model may by an artificial intelligence or machine learning model trained to evaluate image data related to behavioral features included in a media item (e.g., behavioral image data) in order to authenticate the behavioral image data included in the media item, and, ultimately, to determine whether the media item includes manipulated behavioral content with respect to behavioral features of the entity.

The learning engine 455 may develop the behavioral recognition model to extract one or more behavioral features of the behavioral image data included in the media item in order to determine an authenticity of the behavioral image data (e.g., determine whether the media content includes manipulated behavioral content). In some examples, the learning engine 455 may develop the behavioral recognition model using authenticated (or genuine) behavioral image data of an entity as training data. Based on the training data, the behavioral recognition model may be specifically trained to recognize (or learn) behavioral features specific to a particular entity, which may represent a behavioral signature of a particular entity. A behavioral signature may be based on, e.g., a learned set of behavioral features or a baseline of behavioral features for a particular entity. In some instances, the extracted behavioral features may be compared with the behavioral signature of an entity to determine a consistency between the extracted behavioral features and the behavioral signature in order to, ultimately, determine whether the media content includes a behavioral manipulation of the entity.

Accordingly, in some configurations, the AI model may be a single AI model. Alternatively, in other configurations, the AI model may include multiple AI models. As such, the AI model may perform the functionality (or portion(s) thereof) described herein as being performed by another model, such as, e.g., the facial recognition model, the behavioral recognition model, the audio recognition model, another model described herein, or the like.

In some configurations, the learning engine 455 may develop the AI model to perform object recognition functionality, such as, e.g., to recognize or detect an object or an entity included in a media item. For instance, in some configurations, the AI model may include (or otherwise be) a multimodal recognition model. The multimodal recognition model may by an artificial intelligence or machine learning model trained to recognize (or otherwise detect) an entity (or an object) in a media item, such as, e.g., a media item that includes audio data, visual data, another type of data, or a combination thereof. In some instances, the multimodal recognition model may be trained to determine whether a media item involves an entity, such as, e.g., an entity included in a list of entities to be monitored (represented in FIG. 4 as an entity list 470, which is described in greater detail herein). A media item may involve an entity when the media item includes content that depicts (or otherwise represents) an entity (e.g., includes authentic content of the entity, content that impersonates the entity, or a combination thereof). In some examples, the learning engine 455 may train the multimodal recognition model using authentic (or genuine) data that depicts or represents the entity, such that the multimodal recognition model may learn an entity signature specific to that particular entity. The multimodal recognition model may utilize the entity signature(s) when determining whether a media item involves one or more entities included in a list of entities to be monitored (e.g., the entity list 470).

The model(s) generated by the learning engine 455 can be stored in the model database 460. As illustrated in FIG. 4, the model database 460 is included in the memory 410 of the detection server 150. It should be understood, however, that, in some configurations, the model database 460 may be included in a different component of the detection server 150, a separate device accessible by the detection server 150 (e.g., a remote database, the server 300, another component of the 5GC 140, or the like), etc.

As illustrated in FIG. 4, the memory 410 may also include the entity list 470. As noted herein, the entity list 470 may include a list of entities to be monitored. An entity to be monitored may represent an entity that AI manipulated media is to be detected for. For example, when the entity list 470 includes a first entity and a second entity, the technology disclosed herein (e.g., the model(s) described herein) may monitor media items for manipulated content related to the first entity and the second entity. Following this example, when a media item includes a first entity and a third entity, the technology disclosed herein may determine whether the media item includes manipulated content related to the first entity, but not the third entity (as the third entity is not included in the entity list 470). In some examples, the entity list 470 may be established by a user, such as, e.g., an end-user or consumer, a service provider (or agent thereof), a governing or regulatory entity (or agent thereof), a media platform provider (or agent thereof), etc. Accordingly, in some configurations, the AI manipulated media detection may be specifically configured to detect manipulated media with respect to a user-defined list of entities.

The memory 410 may also include a source list 475. The source list 475 may include a list of sources (or media sources) to be monitored. A media source may represent a creator, a distributor, or a publisher of media content. As one example, a source may be a particular media platform provider, such as, e.g., a particular social media platform or website (e.g., the media platform 155 of FIG. 1). As another example, a source may be a particular media content creator, such as, e.g., an author or originator that generated or created the media content (e.g., a particular social media influencer or the like). For example, when the source list 475 includes a first source and a second source, the technology disclosed herein (e.g., the model(s) described herein) may monitor media items associated with the first source and the second source for AI manipulated media. In some examples, the source list 475 may be established by a user, such as, e.g., an end-user or consumer, a service provider (or agent thereof), a governing or regulatory entity (or agent thereof), a media platform provider (or agent thereof), etc. Accordingly, in some configurations, the AI manipulated media detection may be specifically configured to detect manipulated media with respect to a user-defined list of sources. For example, a user may specify which sources to monitor such that, when media items are made accessible via those sources, the technology disclosed herein may facilitate AI manipulated media detection with respect to the media items made accessible via those sources.

As illustrated in FIG. 4, the memory 410 may include a media database 480. In some configurations, the media database 480 may include a list of manipulated media items (e.g., media items classified as manipulated media). For example, in some configurations, when the AI model(s) described herein determine that a media item includes manipulated content, the media item may be classified as manipulated media and may be added to the list of manipulated media items. For instance, in some cases, the list of manipulated media items may be a blacklist of media items. In some instances, the technology disclosed herein may utilize the list of manipulated media items to determine whether a media item has already been previously classified as being manipulated media. When a media item is included in the list of manipulated media items, the technology disclosed herein may not re-determine whether the media item includes manipulated content. Rather, in some configurations, the technology disclosed herein may determine the media item includes manipulated content based on the inclusion of the media item in the list of manipulated media items. As such, in some instances, once a media item is determined as including manipulated media, the media item is not re-checked for manipulated media (e.g., such that, when the media item is subsequently received, the media item is automatically classified as manipulated media).

The memory 410 may include additional, different, or fewer components in different configurations than illustrated in FIG. 4. Alternatively, or in addition, in some configurations, one or more components of the memory 410 may be combined into a single component, distributed among multiple components, or the like. Alternatively, or in addition, in some configurations, one or more components of the memory 410 may be stored remotely from the detection server 150, or, in a remote database, another server (e.g., the server 300 of the 5GC 140), a remote user device, an external storage device, or the like.

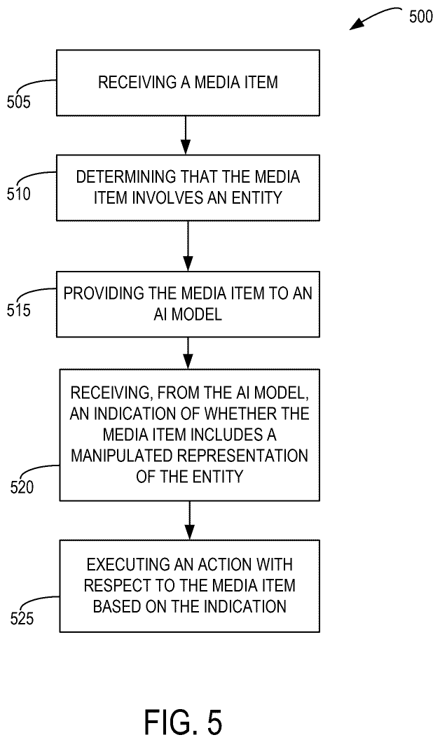

FIG. 5 is a flowchart illustrating an example method 500 to detect AI manipulation of media within the telecommunications network 100 in accordance with some configurations. The method 500 is described as being performed by the detection server 150 and, in particular, the electronic processor(s) 405. However, as noted above, the functionality (or a portion thereof) described with respect to the method 500 may be performed by other devices, such as, e.g., another server or device within the telecommunications network 100 (e.g., the server 300 of the 5GC 140), or distributed among a plurality of devices, such as a plurality of servers included in a cloud service. Thus, although described as begin performed by the detection server 105, the method 500 may also be described as being performed by a processing system including one or more electronic processors (e.g., another processor or processors of the telecommunication network 100).

As illustrated in FIG. 5, the electronic processor 405 may receive a media item (at block 505). As described herein, a media item may include digital media or content (or media content). In some instances, the media item may be published to the media platform 155 (e.g., such that the media item is made publicly accessible via the media platform 155). In some configurations, the electronic processor 405 may receive the media item responsive to the media item becoming accessible (or otherwise available). For example, the electronic processor 405 may receive the media item responsive to the media item being published (or otherwise posted) via the media platform 155. Alternatively, or in addition, in some instances, the electronic processor 405 may receive the media item responsive to a user interacting (or otherwise interfacing) with the media item (e.g., interacting with the media item on the media platform 155 via a UE 110 communicating with the media platform 155 over the RAN 130 and the 5GC 140). For example, in some configurations, the electronic processor 405 may receive the media item as part of a manual request provided by a user (e.g., transmitted by a UE 110 over the RAN 130 and the 5GC 140), where the manual request is a request to determine whether the media item includes manipulated content. As another example, in some configurations, the electronic processor 405 may receive the media item (e.g., received over the 5 GC 140 from a UE 110 or the media platform 155), responsive to a user directly interacting with the media item (e.g., viewing the media item, downloading the media item, sharing the media item, commenting on the media item, providing a reaction to the media item, etc.) for example, using a UE 110 to interact with the media item via the RAN 130 and the 5GC 140.

Alternatively, or in addition, in some configurations, the electronic processor 405 may receive the media item prior to the media item becoming accessible (e.g., publicly accessible via the media platform 155). For example, in some cases, the electronic processor 405 may receive the media item as part of a pre-publication process that verifies content prior to the content being published (e.g., via the media platform 155).

In some instances, the electronic processor 405 may receive the media item based on information or data included in the source list 475. For instance, when the media item is associated with a source included in the source list 475 (e.g., the media item is associated with a source to be monitored, as described in greater detail herein), the electronic processor 405 may receive the media item. However, in instances when media items are not included in the source(s) included in source list 475, the electronic processor 405 may not receive those media items (as those media items are not associated with a source to be monitored). Accordingly, in some cases, whether a media item is received for manipulated content detection by the electronic processor 405 may be based on whether the media item is associated with a source included in the source list 475.

The electronic processor 405 may determine that the media item involves an entity (block 510). In some instances, the electronic processor 405 may determine that the media item involves an entity that is included in the entity list 470. As described in greater detail herein, in some configurations, the electronic processor 405 may determine that the media item involves the entity using a model described herein, such as, e.g., the multimodal recognition model. Accordingly, in some examples, the electronic processor 405 may invoke (or otherwise execute) the multimodal recognition model with respect to the media item. For instance, the multimodal recognition model may utilize one or more entity signatures to determine whether the media item involves an entity included in the entity list 470.

Alternatively, or in addition, in some instances, the electronic processor 405 may analyze additional information or data related to the media item to determine whether the media item involves an entity in the entity list 470. For instance, the electronic processor 405 may determine whether the media item involves an entity in the entity list 470 based on metadata related to the media item, user interactions with the media item (e.g., whether comments related to the media item identify an entity in the entity list 470), etc.

When the electronic processor 405 determines that the media item does not include an entity in the entity list 470, the electronic processor 405 may not determine whether the media item includes AI manipulated media (e.g., manipulated content). In some instances, the electronic processor 405 may facilitate an action with respect to the media item when the media item does not involve an entity in the entity list 470. As one example, the electronic processor 405 may notify a user (e.g., via a transmission to a UE 110 of the user over the RAN 130 and 5GC 140) that the media item does not include an entity in the entity list 470 (e.g., such as in instances where the user submitted a manual request for the media item). Following this example, when a user submitted the manual request for the media item, but the media item does not involve an entity in the entity list 470, the electronic processor 405 may prompt the user (e.g., via a transmission to a UE 110 of the user over the RAN 130 and 5GC 140) to confirm whether that user still wants AI manipulated media detection performed with respect to the media item. When the electronic processor 405 receives a confirmation from the user (e.g., via a response from the UE 110 over the RAN 130 and 5GC 140), the electronic processor 405 may proceed with the method 500. As another example, the electronic processor 405 may allow the media item to become accessible via the media platform 155 (e.g., to become publicly accessible). In some configurations, the electronic processor 405 may allow the media item to become accessible by communicating the media item to the media platform 155, the UE(s) 110, etc. In some instances, the electronic processor 405 may allow the media item to become accessible by marking or otherwise labeling the media item as not including (or not likely including) manipulated content of entities in the entity list 470. As yet another example, the electronic processor 405 may facilitate a user interaction with the media item, such as, e.g., allowing a user to share, download, comment on, etc. the media item. In some configurations, the electronic processor 405 may communicate to the media item to the media platform 155, the UE(s) 110, etc. an enable command indicating to the media platform 155, the UE(s) 110, etc. that one or more interactions with the media item are permitted, where the one or more interactions may previously have been disable on or by the media platform 155, the UE(s) 110, etc.

When the electronic processor 405 determines that the media item does include an entity in the entity list 470, the electronic processor 405 may provide the media item to an AI model (at block 515). As described in greater detail herein, in some instances, the electronic processor 405 may provide the media item to the AI model such that the AI model may determine whether the media item includes manipulated content (or a manipulated representation of the entity). As described in greater detail herein, in some instances, the electronic processor 405 may provide the media item to a voice recognition model, a facial recognition model, a behavioral recognition model, or a combination thereof. In some configurations, the electronic processor 405 may select an AI model (or models) based on, e.g., an entity associated with the media item, a media type of the media item, etc. and the AI model(s) that receive the media item (e.g., in block 515) are the AI model(s) that were selected. For instance, in some configurations, the electronic processor 405 may select the AI model(s) based on which AI model(s) have been specifically developed (or trained) with respect to the entity associated with the media item. For example, when the media item includes an entity A (e.g., as determined in block 510), the electronic processor 405 may select an AI model (or AI models) from the AI model database 460 that were specifically developed (or trained) with respect to entity A and may provide the media item to the selected AI model(s). To select the AI model, the electronic processor 405 may access a lookup table or indexing data in a memory (e.g., the memory 410) that associates or identifies AI models with particular respective entities (e.g., entity A maps to AI model 1, entity B maps to AI models 2 and 3, etc.).

Responsive to receiving the media item, the AI model(s) may extract features from the media item (e.g., facial features, audio features, behavioral features, etc.). The AI model(s) may compare the extracted features to an associated signature (e.g., a facial signature for the entity, an audio signature for the entity, a behavioral feature for the entity, etc.). Based on the comparison, the AI model(s) may determine a consistency or similarity between the extracted features and the associated signature to, ultimately, determine whether the media item includes manipulated content (or a manipulated representation) related to the entity. As described in greater detail herein, in some instances, the AI model(s) may determine whether the media item includes manipulated content (or a manipulated representation) based on the threshold(s) 465. The AI model(s) may provide (or otherwise output) an indication of whether the media item includes manipulated content (or a manipulated representation).

Accordingly, in some instances, the electronic processor 405 may receive, from the AI model(s), an indication of whether the media item includes the manipulated representation of the entity (at block 520). In some instances, the indication may provide specific information related to the manipulated content (or manipulated representation). As one example, the indication may indicate whether the manipulation is a voice manipulation, a facial manipulation, a behavioral manipulation, etc. As another example, the indication may indicate a confidence level associated with whether the media item includes manipulated content (or a manipulated representation). As yet another example, the indication may indicate the entity involved in the media item, a source of the media item, an identification of a creator of the media item, etc.

The electronic processor 405 may execute an action with respect to the media item based on the indication (at block 525). For instance, the electronic processor 405 may execute (or otherwise facilitate) an action based on whether the media item includes manipulated content (or a manipulated representation).

For example, in some configurations, when the indication indicates that the media item does not include manipulated content (or a manipulated representation) of the entity, the electronic processor 405 may transmit the media item, such as, e.g., to a UE (e.g., the UE 110) for display. For instance, the electronic processor 405 may facilitate transmission, distribution, or publication of the media item via the telecommunications network 100.

Alternatively, or in addition, in some configurations, when the indication indicates that the media item includes manipulated content (or a manipulated representation) of the entity, the electronic processor 405 may prevent transmission of the media item, such as, e.g., to a UE (e.g., the UE 110) for display. For instance, the electronic processor 405 may block (or otherwise prevent) transmission, distribution, or publication of the media item via the telecommunications network 100.

Alternatively, or in addition, in some configurations, when the indication indicates that the media item includes manipulated content (or a manipulated representation) of the entity, the electronic processor 405 may add the media item (or an identifier thereof) to the media database 480 (e.g., the list of manipulated media), as described in greater detail herein.

Alternatively, or in addition, in some configurations, when the indication indicates that the media item includes manipulated content (or a manipulated representation) of the entity, the electronic processor 405 may supplement the media item with the indication such that the media item is flagged (or otherwise indicated) as being manipulated media. In some instances, the electronic processor 405 may supplement the media item itself, such as, e.g., by adding a visual or audible indicator to the media item. In some configurations, subsequent to supplementing the media item with the indication, the electronic processor 405 may facilitate transmission of the media item (with the indication supplemented thereto), such as, e.g., to the UE 110 for display. For instance, the electronic processor 405 may facilitate transmission, distribution, or publication of a supplemented version of the media item via the telecommunications network 100. In some instances, the electronic processor 405 may facilitate transmission, distribution, or publication of the supplemented version of the media item via the telecommunications network 100 while blocking the transmission of the original (or un-supplemented) version of the media item.

Alternatively, or in addition, in some configurations, when the indication indicates that the media item includes manipulated content (or a manipulated representation) of the entity, the electronic processor 405 may transmit a notification (or alert) indicating that the media item includes manipulated content (or a manipulated representation) of the entity. In some instances, the notification (or alert) may indicate the manipulated content (or the manipulated representation) of the entity with respect to the media item. In some configurations, the electronic processor 405 may transmit the notification (or alert) to one or more of the UEs 110. As one example, the electronic processor 405 may transmit the notification (or alert) to a UE that is internal to the media platform 155 (e.g., a UE of a media platform provider or agent thereof), such that, e.g., the UE is associated with publication of the media item via the media platform 155. As another example, the electronic processor 405 may transmit the notification (or alert) to a UE that is external to the media platform 155 (e.g., a UE of an end-user or consumer), such that, e.g., the UE is associated with interacting with the media item via the media platform155. As yet another example, the electronic processor 405 may transmit the notification (or alert) to a UE of a regulatory or governing entity.

Other examples and uses of the disclosed technology will be apparent to those having ordinary skill in the art upon consideration of the specification and practice of the technology disclosed herein. The specification and examples given should be considered exemplary only, and it is contemplated that the appended claims will cover any other such embodiments or modifications as fall within the true scope of the technology disclosed herein.

The Abstract accompanying this specification is provided to enable the United States Patent and Trademark Office and the public generally to determine quickly from a cursory inspection the nature and gist of the technical disclosure and in no way intended for defining, determining, or limiting the present technology disclosed herein or any of its embodiments.

What is claimed is:

1. A system to detect artificial intelligence (AI) manipulation of media within a telecommunications network, comprising:
a processing system including one or more electronic processors configured to:
receive a media item published to a media platform such that the media item is made publicly accessible via the media platform;
determine that the media item involves an entity included in a list of entities to be monitored;
provide the media item to an artificial intelligence (AI) model, the AI model to determine whether the media item includes a manipulated representation of the entity;
receive, from the AI model, an indication of whether the media item includes the manipulated representation of the entity; and
execute an action with respect to the media item based on the indication.

2. The system of claim 1, wherein the action includes at least one of:
transmission of the media item to a user equipment (UE);
supplementing the media item with the indication;
providing an alert indicative of the indication to the UE; or blocking the media item from being displayed on the UE.

3. The system of claim 1, wherein the processing system is configured to:
select the AI model from a plurality of AI models based on the entity, wherein the AI model is developed using training data related to the entity such that the AI model is specific to the entity.

4. The system of claim 1, wherein the processing system is configured to:
select the AI model from a plurality of AI models based on a media type of the media item.

5. The system of claim 1, wherein the AI model includes at least one of:
a voice recognition model configured to detect, within the media item, manipulation related to an audio of the entity;
a facial recognition model configured to detect, within the media item, manipulation related to a facial feature of the entity; or
a behavioral recognition model configured to detect, within the media item, manipulation related to a behavioral feature of the entity.

6. The system of claim 1, wherein the processing system is configured to:
receive the media item responsive to a user equipment (UE) interacting with the media item.

7. The system of claim 1, wherein the list of entities to be monitored is generated based on a set of user preferences.

8. The system of claim 1, wherein the processing system is configured to:
receive the media item responsive to a manual request to determine whether the media item includes manipulated content.

9. A method to detect artificial intelligence (AI) manipulation of media within a telecommunications network, the method comprising:
receiving, with a processing system including one or more electronic processors, a media item published to a media platform such that the media item is made publicly accessible via the media platform;
determining, with the processing system, that the media item involves an entity included in a list of entities to be monitored;
providing, with the processing system, the media item to an artificial intelligence (AI) model, the AI model to determine whether the media item includes a manipulated representation of the entity;
receiving, with the processing system, from the AI model, an indication of whether the media item includes the manipulated representation of the entity; and
executing, with the processing system, an action with respect to the media item based on the indication.

10. The method of claim 9, wherein executing, with the processing system, the action includes:
transmitting, with the processing system, the media item to a user equipment (UE) for display when the indication indicates that the media item does not include the manipulated representation of the entity.

11. The method of claim 9, wherein executing, with the processing system, the action includes:
preventing, with the processing system, transmission of the media item when the indication indicates that the media item includes the manipulated representation of the entity.

12. The method of claim 9, wherein executing, with the processing system, the action includes:
supplementing, with the processing system, the media item with the indication when the indication indicates that the media item includes the manipulated representation of the entity; and
subsequent to supplementing the media item with the indication, transmitting, with the processing system, the media item with the indication supplemented thereto to a user equipment (UE) for display.

13. The method of claim 9, wherein executing, with the processing system, the action includes:
transmitting, with the processing system, an alert to a user equipment (UE) when the indication indicates that the media item includes the manipulated representation of the entity, wherein the alert indicates the manipulated representation of the entity with respect to the media item.

14. The method of claim 13, wherein transmitting, with the processing system, the alert to the UE includes at least one of:
transmitting, with the processing system, the alert to a first UE internal to the media platform, the first UE associated with publication of the media item via the media platform; or
transmitting, with the processing system, the alert to a second UE external to the media platform, the second UE associated with interacting with the media item via the media platform; or
transmitting, with the processing system, the alert to a third UE external to the media platform, the third UE associated with a regulatory entity that oversees the media platform.

15. The method of claim 9, wherein executing, with the processing system, the action includes:
when the indication indicates that the media item includes the manipulated representation of the entity:
classifying, with the processing system, the media item as manipulated media; and
adding, with the processing system, the media item to a list of manipulated media items, wherein the list of manipulated media items is utilized with respect to a subsequent receipt of the media item such that, when the media item is subsequently received, the media item is automatically classified as manipulated media.

16. A non-transitory computer-readable medium storing instructions that, when executed by one or more electronic processors of a processing system in a telecommunications network, cause the processing system to perform operations comprising:
receiving a media item;
determining that the media item involves an entity included in a list of entities to be monitored;
providing the media item to an artificial intelligence (AI) model, the AI model to determine whether the media item includes manipulated content related to the entity;
receiving, from the AI model, an indication of whether the media item includes manipulated content related to the entity; and
executing an action with respect to the media item based on the indication.

17. The computer-readable medium of claim 16, wherein determining that the media item involves the entity included in the list of entities to be monitored includes:
providing the media item to a multimodal recognition model, the multimodal recognition model configured to recognize whether media involves entities in the list of entities to be monitored; and
receiving, from the multimodal recognition model, an indication that the media item involves the entity.

18. The computer-readable medium of claim 17, wherein providing the media item to the AI model includes:
providing the media item to the AI model responsive to the indication that the media item involves the entity, wherein the AI model is specific to the entity.

19. The computer-readable medium of claim 16, wherein providing the media item to the AI model includes:
providing the media item to at least one of:
a voice recognition model configured to determine whether the media item includes manipulated content related to a voice of the entity;
a facial recognition model configured to determine whether the media item includes manipulated content related to a facial feature of the entity; or
a behavioral recognition model configured to determine whether the media item includes manipulated content related to a behavioral feature of the entity.

20. The computer-readable medium of claim 16, wherein executing the action with respect to the media item based on the indication includes:
when the indication indicates that the media item includes manipulated content related to the entity, preventing publication of the media item to a media platform such that the media item is not made publicly accessible via the media platform; and
when the indication indicates that the media item lacks manipulated content related to the entity, facilitating publication of the media item to the media platform such that the media item is made publicly accessible via the media platform.
